(19) United States
(12) Patent Application Publication
(10) Pub. No.: US 2026/0141904 A1
(43) Pub. Date: May 21, 2026

(54) INFORMATION DISPLAY METHOD AND APPARATUS BASED ON VOICE INTERACTION, AND ELECTRONIC DEVICE

(71) Applicant: Beijing Zitiao Network Technology Co., Ltd., Beijing (CN)

(72) Inventors: Xiang LI, Beijing (CN); Wenhai YANG, Beijing (CN)

(21) Appl. No.: 19/119,396

(22) PCT Filed: Aug. 17, 2023
(86) PCT No.: PCT/CN2023/113531

§ 371 Date: Apr. 8, 2025

(30) Foreign Application Priority Data
Oct. 31, 2022 (CN) 202211351762.7

(51) Int. Cl. G10L 15/26; G10L 15/04

(52) U.S. Cl. CPC G10L 15/26; G10L 15/04

(57) ABSTRACT

An information display method and apparatus based on voice interaction, and an electronic device. A specific embodiment of the method comprises: on the basis of operation information of an interaction-related document for real-time voice interaction, determining an interaction segment of the real-time voice interaction (101); and displaying segment information of the determined interaction segment (102). Therefore, a novel information display mode based on voice interaction is provided.

### CROSS-REFERENCE TO RELATED APPLICATION(S)

The present application claims priority to Chinese Patent Application No. 202211351762.7, filed on Oct. 31, 2022, and entitled “INFORMATION DISPLAY METHOD AND APPARATUS BASED ON VOICE INTERACTION, AND ELECTRONIC DEVICE”, which is incorporated herein by reference in its entirety.

### TECHNICAL FIELD

The present disclosure relates to the field of Internet technologies, and in particular, to an information display method and apparatus based on voice interaction, and an electronic device.

### BACKGROUND

With the development of the Internet, users increasingly use the functions of terminal devices, making work and life more convenient. For example, a user may start real-time voice interaction with another user online through the terminal device. Through online real-time voice interaction, users can implement long-distance interaction and start interaction without gathering in one place. Real-time voice interaction largely avoids the limitations of traditional face-to-face interaction on locations and venues.

### SUMMARY

This summary is provided to introduce the concepts in a simplified form, which will be described in detail in the following Detailed Description of Embodiments section. This summary is not intended to identify the key features or essential features of the claimed technical solution, nor is it intended to be used to limit the scope of the claimed technical solution.

In a first aspect, an embodiment of the present disclosure provides an information display method based on voice interaction, the method including: determining an interaction segment of a real-time voice interaction based on operation information for an interaction-related document for the real-time voice interaction; and displaying segment information of the determined interaction segment.

In a second aspect, an embodiment of the present disclosure provides an information display method based on voice interaction, the method including: obtaining a voice recognition result based on voice recognition performed on a voice signal period in a real-time voice interaction; determining an interaction segment of the real-time voice interaction based on the voice recognition result; and displaying segment information of the determined interaction segment.

In a third aspect, an embodiment of the present disclosure provides an information display apparatus based on voice interaction, including: a recognition module configured to obtain a voice recognition result based on voice recognition performed on a voice signal period in a real-time voice interaction; a determination module configured to determine an interaction segment of the real-time voice interaction based on the voice recognition result; and a display module configured to display segment information of the determined interaction segment.

In a fourth aspect, an embodiment of the present disclosure provides an information display apparatus based on voice interaction, including: a determination unit configured to determine an interaction segment of a real-time voice interaction based on operation information for an interaction-related document for the real-time voice interaction; and a display unit configured to display segment information of the determined interaction segment.

In a fifth aspect, an embodiment of the present disclosure provides an electronic device, including: one or more processors; and a storage apparatus configured to store one or more programs, when the one or more programs are executed by the one or more processors, the one or more processors are caused to implement the information display method based on voice interaction according to the first aspect.

In a sixth aspect, an embodiment of the present disclosure provides a computer-readable medium having a computer program stored thereon, when the program is executed by a processor, the steps of the information display method based on voice interaction according to the first aspect are implemented.

### BRIEF DESCRIPTION OF THE DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a flowchart of an embodiment of an information display method based on voice interaction according to the present disclosure;

FIG. 2 is a flowchart of an optional implementation of the present disclosure;

FIG. 3 is a flowchart of an optional implementation of the present disclosure;

FIG. 4 is a schematic diagram of an application scenario of an information display method based on voice interaction according to the present disclosure;

FIG. 5 is a schematic diagram of an application scenario of an information display method based on voice interaction according to the present disclosure;

FIG. 6 is a schematic diagram of an application scenario of an information display method based on voice interaction according to the present disclosure;

FIG. 7A is a schematic diagram of an application scenario of an information display method based on voice interaction according to the present disclosure;

FIG. 7B is a schematic diagram of an application scenario of an information display method based on voice interaction according to the present disclosure;

FIG. 7C is a schematic diagram of an application scenario of an information display method based on voice interaction according to the present disclosure;

FIG. 8 is a flowchart of an embodiment of an information display method based on voice interaction according to the present disclosure;

FIG. 9 is a schematic diagram of a structure of an embodiment of an information display apparatus based on voice interaction according to the present disclosure;

FIG. 10 is a schematic diagram of a structure of an embodiment of an information display apparatus based on voice interaction according to the present disclosure;

FIG. 11 is an exemplary system architecture in which the information display method based on voice interaction according to an embodiment of the present disclosure can be applied; and

FIG. 12 is a schematic diagram of a basic structure of an electronic device provided according to an embodiment of the present disclosure.

### DETAILED DESCRIPTION OF EMBODIMENTS

Embodiments of the present disclosure are described in more detail below with reference to the accompanying drawings. Although some embodiments of the present disclosure are shown in the drawings, it would be appreciated that the present disclosure can be implemented in various forms and should not be construed as being limited to the embodiments set forth herein. On the contrary, these embodiments are provided for a more thorough and complete understanding of the present disclosure. It should be understood that the accompanying drawings and embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The terms “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, it should be understood as “one or more”.

Names of messages or information exchanged between a plurality of apparatuses in the implementations of the present disclosure are used for illustrative purposes only, and are not used to limit the scope of these messages or information.

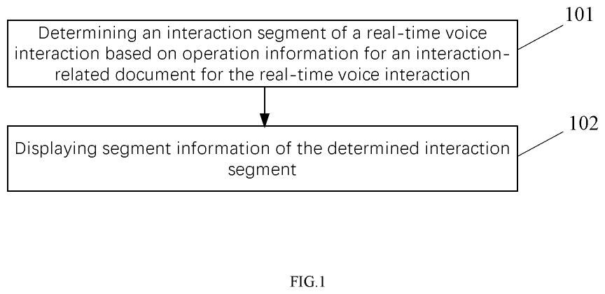

Reference is made to FIG. 1, which shows a flow of an embodiment of an information display method based on voice interaction according to the present disclosure. As shown in FIG. 1, the information display method based on voice interaction includes the following steps:

Step 101: Determining an interaction segment of a real-time voice interaction based on operation information for an interaction-related document for the real-time voice interaction.

In this embodiment, an execution subject (for example, a server and/or a terminal device) of the information display method based on voice interaction may determine the interaction segment of the real-time voice interaction based on the operation information for the interaction-related document for the real-time voice interaction. It would be appreciated that the real-time voice interaction may be understood as voice interaction, and a segment of the real-time voice interaction may be referred to as an interaction segment.

In this embodiment, the real-time voice interaction may be voice interaction performed in real time by using an electronic device, and may include, for example, online interaction performed by using a multimedia manner. The multimedia may include but is not limited to at least one of audio or video. A real-time voice interaction interface may be a related interface for the real-time voice interaction.

In this embodiment, the application for starting the real-time voice interaction may be any type of application, and is not limited here. For example, the above application may be an instant video interaction application, a communication application, a video playback application, a mail application, or the like.

Here, the interaction segment of the real-time voice interaction may be bound to an interaction time point, and a time period between two interaction time points is used as the interaction segment.

Here, the interaction-related document may include a document related to the interaction. As an example, the interaction-related document may include but is not limited to at least one of the following: a shared document bound to the interaction or a document displayed during a screen being shared. The shared document bound to the interaction may be bound to the interaction before the interaction, or may be bound to the interaction during the interaction (that is, a document shared during a meeting).

Here, the operation information for the interaction-related document may indicate an operation on the interaction-related document.

As an example, the operation on the interaction-related document may include but is not limited to at least one of the following: switching between documents, opening a document, closing a document, browsing a document, selecting a document title, or commenting on a document.

As an example, the interaction segment may be determined based on a switching operation of a user on different interaction-related documents. A time point when the user switches between different interaction-related documents may be used as the interaction segment.

As an example, the interaction segment may be determined based on an operation of the user switching a title of the interaction-related document. A time point when the user performs an operation of switching a title of the interaction-related document each time may be used as a boundary point of the interaction segment.

As an example, the interaction segment may be determined based on an operation of the user browsing the interaction-related document. A time point when a page turning operation is performed on the interaction-related document may be used as a boundary point of the interaction segment.

Step 102: Displaying segment information of the determined interaction segment.

In this embodiment, the execution subject may display the segment information of the determined interaction segment.

In this embodiment, the segment information may indicate a related condition of the interaction segment. The segment information may include but is not limited to at least one of the following: segment time or segment topic.

In this embodiment, an information display position of the segment may be determined based on an actual application scenario, and is not limited here.

As an example, the segment information may be displayed in an interaction summary area.

As an example, the segment information may include text obtained by converting an interaction voice.

In some embodiments, the solution of the present application may be implemented offline, or may be performed in real time for the real-time voice interaction. Segmentation performed on a record of a real-time multimedia meeting is essentially an offline process.

It should be noted that in the information display method based on voice interaction provided in this embodiment, the interaction segment of the real-time voice interaction is determined based on the operation information for the interaction-related document, which can provide a new manner of determining the interaction segment, so that the determined interaction segment may refer to a document display process of the interaction-related document. It would be appreciated that in the real-time voice interaction, a participating user may perform interaction in accordance with the display process of the interaction-related document. Therefore, the interaction segment is determined based on the operation information for the interaction-related document, and the segment information is displayed, so that an interaction segment that is consistent with the real-time voice interaction process more accurately can be determined, and the accuracy of determining the interaction segment and interaction information is improved.

In contrast, in some related technologies, there is no good record of the interaction segment, and the user has low efficiency when viewing the interaction recording result, and needs to manually drag the progress bar to find a part related to the user. The embodiments of the present application implement document-based interaction video segmentation, which can effectively structure the interaction and help the user to search for and locate the interaction content.

In some embodiments, the above step 101 may include: determining the interaction segment of the real-time voice interaction based on the operation information for the interaction-related document and a sound signal of the real-time voice interaction.

Here, the sound signal of the real-time voice interaction may be classified into different classifications based on different classification criteria.

As an example, if the sound signal is classified based on whether the sound signal includes a voice, the sound signal may include a voice signal and a non-voice signal; and if the sound signal is classified based on a sound intensity, the sound signal may include a sound signal greater than a preset intensity threshold and a sound signal not greater than the preset intensity threshold.

In some embodiments, a part with a sound intensity greater than the preset intensity threshold may be first detected based on the preset intensity threshold, and then the voice signal is detected in this part. Therefore, the sound signal may be divided into a voice signal period and a period that does not include a voice signal.

In some embodiments, the period in the sound signal that does not include the voice signal may be used as a boundary of the interaction segment. In addition, the voice signal period in the sound signal may be segmented based on the operation information for the interaction-related document. For example, an operation of switching the interaction-related document in the voice signal period may be used as a boundary point of the voice signal period, to segment the voice signal period.

It should be noted that in the process of the real-time voice interaction, the participating user may stop speaking when switching to content of different topics, and the period when the user stops speaking may indicate a boundary point between the interaction segments of the real-time voice interaction. Therefore, the real-time voice interaction is segmented in combination with the operation information for the interaction-related document and the sound signal of the real-time voice interaction, so that when the interaction segment is segmented, the two pieces of information, namely the operation information and the sound signal, that can represent the boundary point of the interaction segment may be referred to, to determine a more accurate interaction segment.

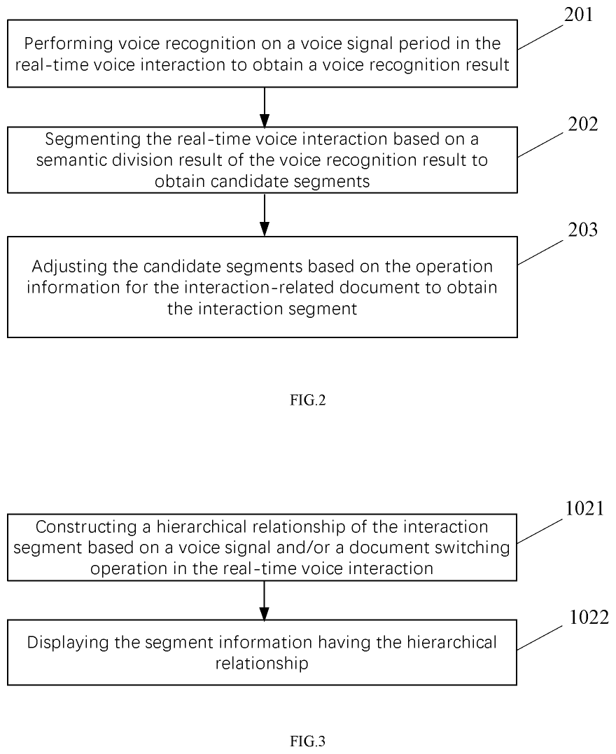

In some embodiments, the above step of determining the interaction segment of the real-time voice interaction based on the operation information for the interaction-related document and the sound signal of the real-time voice interaction may include the flow shown in FIG. 2. The flow shown in FIG. 2 may include step 201, step 202, and step 203.

Step 201: Performing voice recognition on a voice signal period in the real-time voice interaction to obtain a voice recognition result.

Here, the sound signal of the real-time voice interaction may include a voice signal. Therefore, the voice signal period may be determined from the real-time voice interaction based on whether the period includes a voice signal that lasts for a preset duration. In the determination of lasting for the preset duration, an interruption duration threshold may be set. If an interruption duration between two voice signals is less than the interruption duration threshold, it may be considered that the two voice signals are continuous voice signals, and there is no interruption between the two voice signals.

Here, voice recognition may be performed on the voice signal period in the real-time voice interaction to obtain the voice recognition result. The voice recognition result may include text information.

Step 202: Segmenting the real-time voice interaction based on a semantic division result of the voice recognition result to obtain candidate segments.

Here, semantic division may be performed on the voice recognition result to obtain segments corresponding to the text information. Each segment of text information after the segmentation may correspond to a time point of the real-time voice interaction.

In some embodiments, the above step 202 may include: performing semantic division on the voice recognition result to divide the voice recognition result into at least two segments; and determining a boundary point of a segment of the real-time voice interaction based on a time boundary point between two adjacent voice recognition results, to obtain two adjacent candidate segments of the real-time voice interaction.

As an example, semantic division is performed on the voice recognition result to divide the voice recognition result into two segments. Therefore, the time points corresponding to the voice recognition result divided into two segments may be used as the boundary point of the segment of the real-time voice interaction, to obtain two candidate segments of the real-time voice interaction. Therefore, segmentation of multimedia may be implemented to obtain the candidate segments.

Step 203: Adjusting the candidate segments based on the operation information for the interaction-related document to obtain the interaction segment.

In some embodiments, at least one of the following operations may be performed based on the operation information: combining the two candidate segments into one interaction segment, adjusting a time point of an existing candidate segment, or dividing one candidate segment into at least two interaction segments.

It should be noted that through the implementation corresponding to FIG. 2, firstly the candidate segments may be obtained by performing semantic division on the voice recognition result, and then the candidate segments are adjusted based on the operation information for the interaction-related document. Therefore, the accuracy of the interaction segment can be improved.

In some embodiments, the above step of determining the interaction segment of the real-time voice interaction based on the operation information for the interaction-related document and the sound signal of the real-time voice interaction may include: if a duration of a period in the sound signal that does not include a voice signal is greater than a preset first duration threshold, determining this part as a first-type interaction segment.

As an example, a specific value of the preset first duration threshold may be set based on an actual application scenario, for example, may be 30 seconds.

In some embodiments, if the duration of the period in the sound signal that does not include the voice signal is not greater than the preset first duration threshold, this period may be incorporated into a previous period or a subsequent period, or this period may be split, and a part of this period is incorporated into the previous period, and another part of this period is incorporated into the subsequent period.

It should be noted that by determining the duration of the period that does not include the voice signal, a silent period in the interaction may be accurately found. Specifically, the sound signal in the interaction may include a voice signal or a non-voice signal. For a period that includes the non-voice signal, even if the period includes the sound signal, through the segmentation in this implementation, the period may not be involved in the segmentation of the voice signal. Therefore, the accuracy of the interaction segment is improved.

In some embodiments, the above step 203 may include: determining a title switching time of the interaction-related document based on presentation position information of the interaction-related document; and adjusting start and end times of the candidate segments based on the title switching time.

Here, the title switching time is used to indicate a time of switching different subparts of the interaction-related document.

Here, the presentation position information may include document position information bound to a time. The presentation position information may be a position to which the document is presented.

Here, the presentation position information may be determined in a plurality of manners.

In some embodiments, the presentation position information may be determined based on at least one of the following: a title switching operation, document topic information corresponding to a document focus or a comment.

Here, the title switching operation may include a determination of a trigger of a user on different entries in a title, and may further include a determination of a trigger of the user on titles at various levels in the interaction-related document.

Here, the title switching time of the interaction-related document may indicate a switching time of different entries in the title. As an example, a title switching time between a first section and a second section may indicate a time when the user switches the document from the first section to the second section.

Here, the time of the candidate segments is adjusted based on the title switching time.

Here, the user may trigger a comment on the interaction-related document, and the document topic information corresponding to the comment may be used to determine the title switching time. For example, if a change is made from displaying a comment on the first section to displaying a comment on the second section, the change time may be determined as the title switching time.

It should be noted that the start and end times of the candidate segments are adjusted through the title switching time, so that the candidate segments can be adjusted by using the capture of the focus of interaction display in the interaction, and in combination with the sound signal, the segmentation accuracy is comprehensively improved from both the sound and visual aspects.

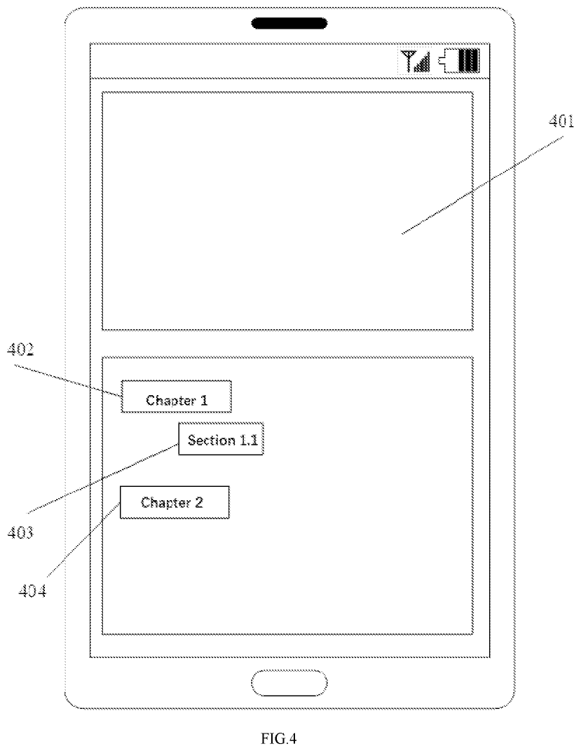

Reference is made to FIG. 3, which shows an optional implementation of the above step 102. The flow shown in FIG. 3 may include step 1011 and step 1012.

Step 1021: Constructing a hierarchical relationship of the interaction segment based on a voice signal and/or a document switching operation in the real-time voice interaction.

Step 1022: Displaying the segment information having the hierarchical relationship.

Here, the document switching operation may be used to switch the interaction-related document for the real-time voice interaction. As an example, there are two interaction-related documents for the real-time voice interaction, which are numbered as a first document and a second document, and the document switching operation may be switching from the first document to the second document.

Here, the hierarchical relationship of the interaction segment is constructed, and the interaction segments may be displayed at different hierarchical levels to reflect a relationship between the interaction segments.

For example, there are three obtained interaction segments, which are numbered as a first segment, a second segment, and a third segment. The hierarchical relationship of the interaction segment is constructed, and the interaction segments are determined as two levels, where the first segment and the third segment belong to a first level, and the second segment belongs to a sub-level of the first segment. Accordingly, the segment information of the first segment and the third segment is used as a first-level interaction title, the segment information of the second segment is used as a second-level interaction title, and the second-level interaction title is below the first-level interaction title corresponding to the first segment.

Here, the displaying the segment information having the hierarchical relationship may include displaying the relationship between the interaction segments in various forms. For example, the segment information of the first segment and the third segment of the first level is displayed in a full-out form, and the segment information of the second segment is indented and displayed below the segment information of the first level.

It should be noted that by constructing the hierarchical relationship of the interaction segment based on the voice signal and the document switching operation in the real-time voice interaction, and displaying the segment information having the hierarchical relationship, a user may be enabled to clearly learn about the hierarchical relationship between the interaction segments, which makes it convenient for the user to understand an interaction structure of the real-time voice interaction.

In some embodiments, the step 1021 may include: determining a first-level interaction title of the real-time voice interaction based on a first-level document title of the interaction-related document in response to no document switching operation being detected in the real-time voice interaction.

Here, a document directory may include titles at a plurality of levels, and a first-level title in the document directory may be referred to as a first-level document title.

Here, the interaction may include segments at a plurality of levels. As an example, a first-level interaction segment may include a second-level interaction segment, and the second-level interaction segment may include a third-level interaction segment. An interaction directory may include interaction titles at a plurality of levels, and a first-level title in the interaction directory may be referred to as a first-level interaction title, to indicate the first-level interaction segment. Titles at various levels in the interaction directory may indicate the interaction segments. Optionally, the titles at various levels in the interaction may be segment topics of the interaction segments, and a hierarchical relationship of the titles at various levels in the interaction is consistent with a hierarchical relationship of the interaction segments.

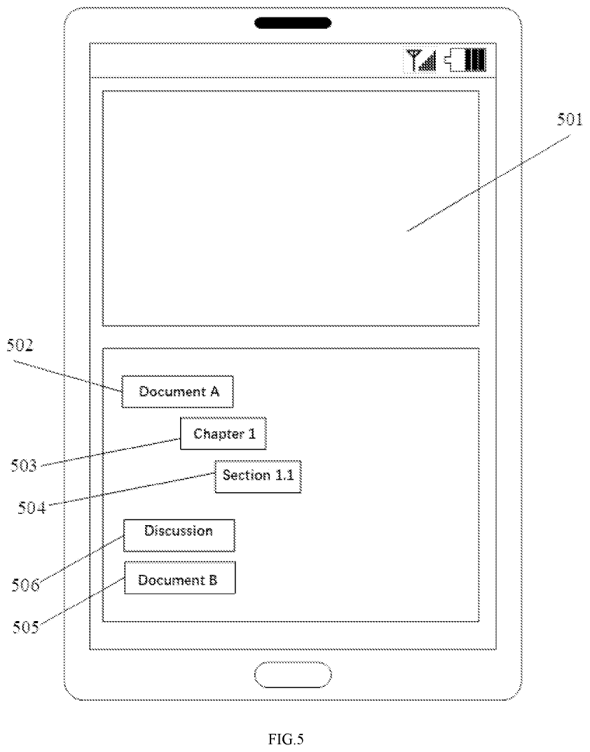

As an example, reference is made to FIG. 4, which shows a scenario in which the first-level document title of the interaction-related document is used as the first-level interaction title.

In FIG. 4, a playback area 401 may play an interaction video of the real-time voice interaction. A first-level interaction title 402 may be a first-level document title of a document A. A second-level interaction title 403 may be a second-level document title in the document A, and the second-level interaction title 403 is a sub-level title of the first-level interaction title 402. In the document A, section 1.1 belongs to chapter 1. The first-level interaction title 403 may be the first-level document title in the document A.

It should be noted that when there is no document switching in the real-time voice interaction, that is, when there is only one interaction-related document, the interaction segments at various levels and the interaction titles of the real-time voice interaction are determined based on the document title of the interaction-related document, so that the interaction process can be quickly and accurately determined in the interaction with the interaction-related document as a main line.

In some embodiments, if there is a document switching in the real-time voice interaction, a document identifier may be used as a first-level title, and the first-level interaction title of the interaction-related document may be used as a second-level title of the interaction segment.

In some embodiments, the step 1021 includes: determining, in response to the document switching operation being detected in the real-time voice interaction, a first-level interaction title of the real-time voice interaction based on a document identifier of the interaction-related document; and determining an N-level interaction title of the real-time voice interaction based on a document title of the interaction-related document, where N≥2.

As an example, reference is made to FIG. 5, which shows a scenario in which the document identifier of the interaction-related document is used as the first-level interaction title.

In FIG. 5, a playback area 501 may play an interaction video of the real-time voice interaction. A first-level interaction title 502 may be a document identifier of a document A. A second-level interaction title 503 may be a first-level document title in the document A, and the second-level interaction title 503 is a sub-level title of the first-level interaction title 502. A third-level interaction title 504 is a sub-level title of the second-level interaction title 503. In the document A, section 1.1 belongs to chapter 1. A first-level interaction title 505 may be a document identifier of a document B.

It should be noted that in the real-time voice interaction with a plurality of interaction-related documents, the document identifier is used as the first-level interaction title, so that the interaction period of the real-time voice interaction may be divided with the document as a main node; and the N-level interaction title (N≥2) of the real-time voice interaction is determined based on the document title, so that a hierarchical relationship may be quickly determined for some interaction segments corresponding to the same interaction-related document with the aid of document segmentation.

In some embodiments, the step 1012 may include: displaying segment information of a second-type interaction segment as a first-level interaction title.

Here, the interaction-related document is not displayed in the real-time voice interaction during the first-type interaction segment.

As an example, for an interaction segment in the real-time voice interaction where the interaction-related document is not shared, if the interaction segment is greater than a preset second duration threshold, the interaction segment is determined as the second-type interaction segment.

As an example, reference is made to FIG. 5, where a first-level interaction title 506 in FIG. 5 may indicate a second-type interaction segment. As shown in FIG. 5, the first-level interaction title 506 may be marked as “discussion”, to indicate that this interaction segment is a discussion between the participating objects.

In some embodiments, the first-type interaction segment and the document identifier of the interaction-related document are at a same level.

It should be noted that the interaction segment where the interaction-related document is not displayed is used as the first-level interaction title, so that the user discussion segment is in parallel with the interaction period where the document is shared, and the hierarchical relationship of the interaction segments may be more accurate and reasonable, and the interaction structure may be quickly determined when it is necessary to review the interaction process.

In some embodiments, the step 1021 may include: for a target interaction period in the real-time voice interaction, determining whether the target interaction period includes a third-type interaction segment based on the voice signal in the target interaction period; and if the target interaction period includes the third-type segment, adding a preset indication identifier for the interaction segment after the third-type interaction segment in the target interaction period.

In some embodiments, if the target interaction period includes the third-type segment, for the interaction segment after the third-type interaction segment in the target interaction period, the level of the segment information is adjusted downward, and the preset indication identifier is displayed before the adjusted segment information. Here, the interaction segments in the target interaction period correspond to the same interaction-related document. As an example, segment topics of the interaction segments in the target interaction period belong to the same interaction-related document.

As an example, the target interaction period includes three interaction segments, the first interaction segment is a communication between users, the second interaction segment is the third-type interaction segment, and the third interaction segment is discussed with a document A as an object.

As an example, the first interaction segment has at least one of the following features: in a recording start stage of the real-time voice interaction, a plurality of persons speak frequently in turn, and the voice is recognized as a short sentence (<30 words/a sentence), and the duration is >1 minute, the video is segmented and marked at the start, and the segment title is “introduction”.

As an example, the second interaction segment has at least one of the following features: after the first interaction segment, a silent segment of >5 minutes appears, which may be considered as a document reading stage (that is, the third interaction segment). After the document reading stage ends, the interaction is segmented in accordance with the document title, and a first-level title “comments” may be added before the document title.

Here, a determination condition of the third-type interaction segment includes a voice silent duration being greater than a third duration threshold (for example, 5 minutes).

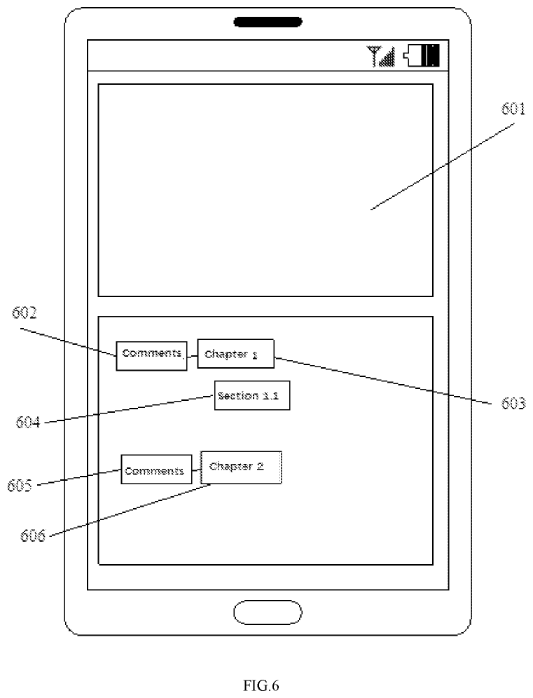

As an example, reference is made to FIG. 6, which shows an example scenario in which the target interaction period includes the third-type interaction segment.

In FIG. 6, a playback area 601 may play an interaction video of the real-time voice interaction. A preset indication identifier 602 (for example, marked as “comments”) may be used as a first-level interaction title, and displayed before a second-level interaction title 603, where the second-level interaction title 603 is a first-level document title of a document A (that is, chapter 1). A third-level interaction title 604 is a sub-level title of the second-level interaction title 603. In the document A, section 1.1 belongs to chapter 1. A preset indication identifier 605 is used as a first-level interaction title, and displayed before a second-level interaction title 606, where the second-level interaction title is a first-level document title of the document A (that is, chapter 2).

It should be noted that by identifying the third-type interaction segment in the target interaction period, it is possible to accurately determine, for the real-time voice interaction in a mode in which the participating objects first read the interaction-related document and then discuss it intensively, whether the silent period is associated with the interaction-related document, so as to determine a main content of the user interaction after the silent period, and indicate the content of the user interaction after the silent period with the preset indication information.

In some embodiments, the segment information may include a segment topic.

The above step 1022 may include: determining the segment topic of the interaction segment based on document content of the interaction-related document in the real-time voice interaction; and displaying the segment topic.

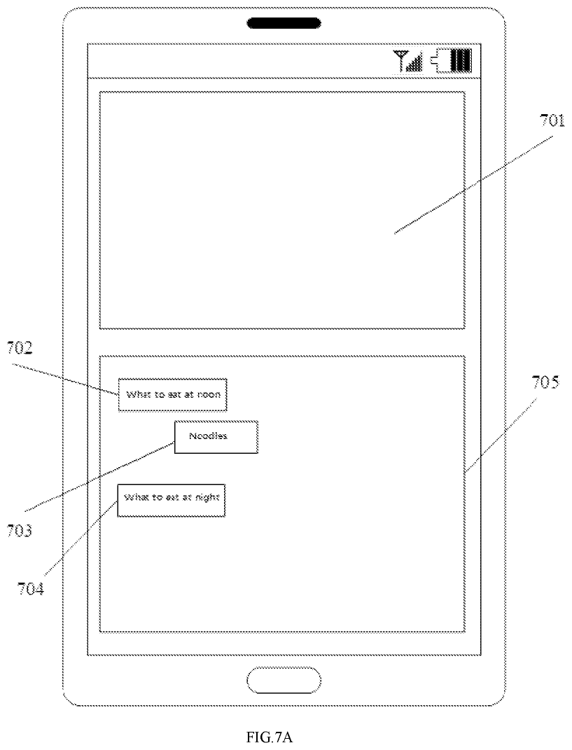

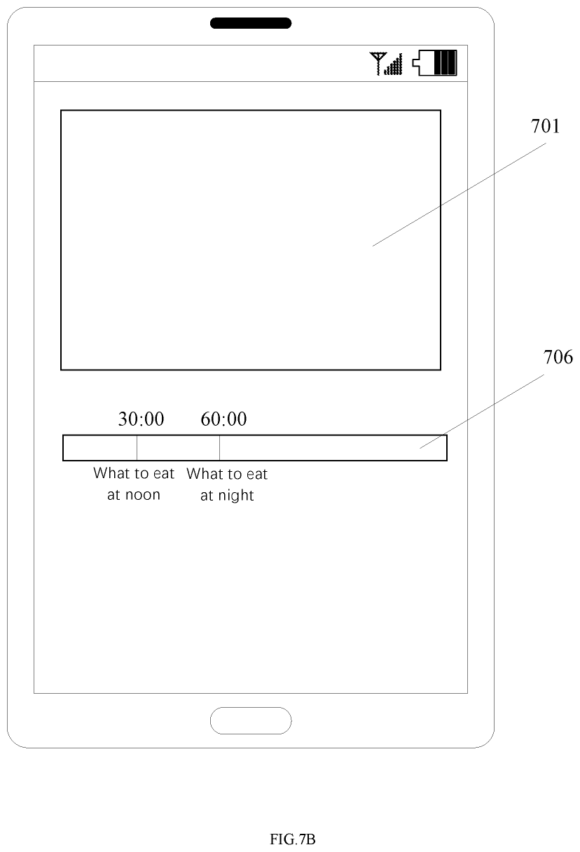

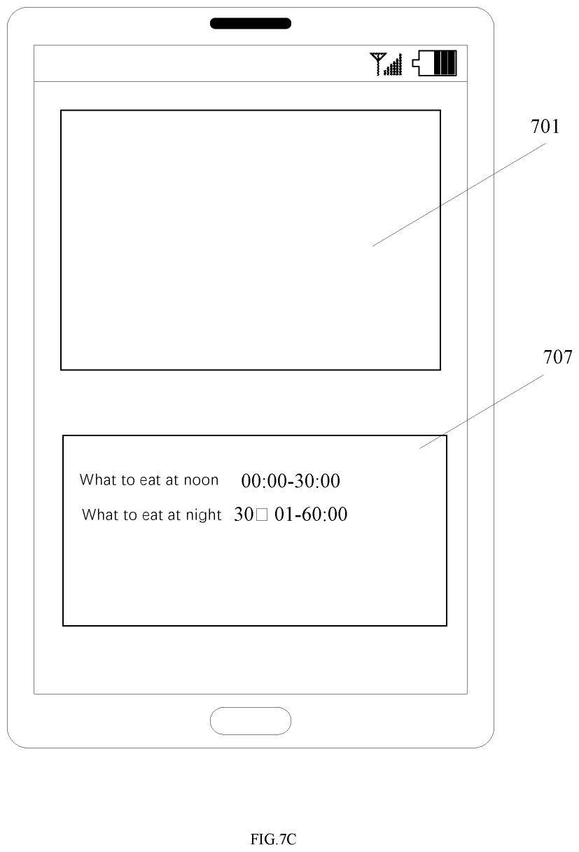

Reference is made to FIG. 7A, which shows a related scenario in which the segment information is displayed.

In FIG. 7A, a playback area 701 may play an interaction video of the real-time voice interaction. The document content of the interaction-related document may include a selection for lunch and dinner. The real-time voice interaction segments may include two segments. The first segment corresponds to a title or an overview of the document content in the document (that is, what to eat at noon), that is, a segment title 702, and a sub-level title 703 (marked with “noodles”) of the segment title 702. The second segment corresponds to another title or an overview of the document content in the document (that is, what to eat at night), that is, a segment title 704.

Thus, the determined segment topic of the interaction segment may refer to the interaction-related document. It would be appreciated that in the real-time voice interaction with the interaction-related document, the segment topic of the interaction segment can be accurately determined by fully using the feature that the interaction-related document is consistent with the interaction, so that the user can quickly learn about the interaction process from the segment topic, and the efficiency of acquiring interaction-related information is improved.

In some embodiments, the displaying the segment topic may include: displaying, in an interaction summary, the segment topic having the hierarchical relationship.

As an example, reference is made to FIG. 7A, which shows an interaction summary display area 705. In the interaction summary display area 705, the segment topic may be displayed, and there is a hierarchical relationship between the segment topics.

In some embodiments, the method further includes: in response to a trigger operation on the displayed segment topic, skipping the recorded interaction video to the triggered interaction segment, and playing the triggered interaction segment.

As an example, when the user triggers the segment title 704 in FIG. 4, the playback area 701 may play the interaction segment indicated by the segment title 704.

Thus, the user may quickly learn about the interaction process with reference to the segment topic. If the user wants to watch the segment in the real-time voice interaction, the user may trigger the segment title to quickly skip to and play the segment corresponding to the triggered title.

In some embodiments, the displaying the segment information of the determined interaction segment includes at least one of the following, but is not limited to the following: displaying the segment information of the determined interaction segment during the real-time voice interaction; or displaying the segment information of the determined interaction segment in a voice recognition result corresponding to the real-time voice interaction during the real-time voice interaction and/or after the real-time voice interaction ends.

It should be noted that displaying the interaction segment information during the voice interaction may facilitate a user in the interaction to check a previous interaction structure in a timely manner, and facilitate the user in the interaction to recall the exchanged interaction content.

It should be noted that displaying the segment information of the interaction segment in the voice recognition result may enable the user to visually obtain the interaction structure when the user recalls the content with the aid of the voice recognition result, and may enable the user to further understand the voice recognition result with the aid of the interaction structure, which helps the user quickly acquire the interaction content.

In some embodiments, the displaying the segment information of the determined interaction segment may include at least one of the following, but is not limited to the following: displaying the segment information corresponding to a time point on a time axis corresponding to the real-time voice interaction; displaying the segment information of the interaction segment in association with document content information; or displaying the segment information of the interaction segment in association with a document structure.

As an example, reference is made to FIG. 7B, where a playback area 701 in FIG. 7B may play an interaction video of the real-time voice interaction, and FIG. 7B shows a time axis 706 corresponding to the real-time voice interaction. The document content of the interaction-related document may include a selection for lunch and dinner. The real-time voice interaction segments may include two segments, that is, what to eat at noon that starts at the 30th minute of the interaction and what to eat at night that starts at the 60th minute of the interaction. On the time axis 706, what to eat at noon corresponding to the 30th minute may be displayed, and what to eat at night corresponding to the 60th minute may be displayed.

In some embodiments, the document content information may be used to indicate the document content. As an example, the document content information may include a document body and a document title. As an example, the segment time corresponding to each body part may be displayed in the document body.

In some embodiments, the document structure may be used to indicate a structure of the document. As an example, the document structure may be a structure of the interaction-related document.

Reference is made to FIG. 7C, where a document structure display area 707 in FIG. 7C may display the document structure, where the document structure includes what to eat at noon indicating a first part of the document and what to eat at night indicating a second part of the document. The segment time of the interaction segment (that is, 00:00-30:00) may be displayed in association with what to eat at noon in the first part of the document; and the segment time of the interaction segment (that is, 30:01-60:00) may be displayed in association with what to eat at night in the second part of the document.

Reference is made to FIG. 8, which shows a flow of an embodiment of an information display method based on voice interaction according to the present disclosure. As shown in FIG. 1, the information display method based on voice interaction includes the following steps:
Step 801: Obtaining a voice recognition result based on voice recognition performed on a voice signal period in a real-time voice interaction to.
Step 802: Determining an interaction segment of the real-time voice interaction based on the voice recognition result.
Step 803: Displaying segment information of the determined interaction segment.

It should be noted that in the embodiment provided in FIG. 8, the interaction segment of the real-time voice interaction may be determined based on the voice recognition result. Therefore, the interaction segment may be determined using the fact that the voice recognition result may indicate a difference in segment content between different interaction segments. Therefore, the accuracy of the interaction segment can be improved.

In some embodiments, the determining the interaction segment of the real-time voice interaction based on the voice recognition result includes: performing voice recognition on the voice signal period in the real-time voice interaction to obtain the voice recognition result; segmenting the real-time voice interaction based on a semantic division result of the voice recognition result to obtain candidate segments; and determining the interaction segment based on a time of the candidate segments.

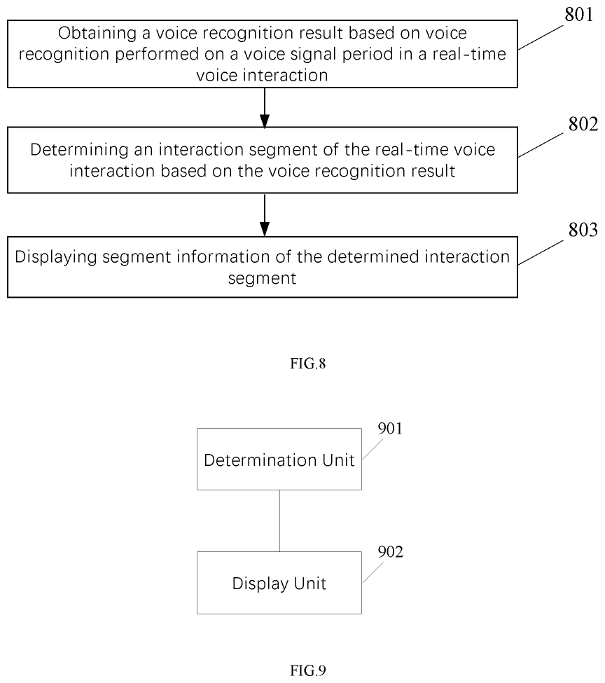

In some embodiments, the segmenting the real-time voice interaction based on the semantic division result of the voice recognition result to obtain the candidate segments includes: performing semantic division on the voice recognition result to divide the voice recognition result into at least two segments; and determining a boundary point of a segment of the real-time voice interaction based on a time boundary point between two adjacent voice recognition results, to obtain two adjacent candidate segments of the real-time voice interaction. It should be noted that the technical features of the embodiment corresponding to FIG. 8 may be combined with any technical features or technical solutions in other embodiments of the present application. With further reference to FIG. 9, as an implementation of the method shown in the foregoing figures, the present disclosure provides an embodiment of an information display apparatus based on voice interaction. This apparatus embodiment corresponds to the method embodiment shown in FIG. 1, and this apparatus may be specifically applied to various electronic devices.

As shown in FIG. 9, the information display apparatus based on voice interaction in this embodiment includes: a determination unit 901 and a display unit 902. The determination unit is configured to determine an interaction segment of a real-time voice interaction based on operation information for an interaction-related document for the real-time voice interaction, and the display unit is configured to display segment information of the determined interaction segment.

In this embodiment, for specific processing of the determination unit 901 and the display unit 902 of the information display apparatus based on voice interaction and the technical effects brought thereby, reference may be made to the related descriptions of step 101 and step 102 in the corresponding embodiment in FIG. 1, respectively, and details are not described here again.

In some embodiments, the determining the interaction segment of the real-time voice interaction based on the operation information for the interaction-related document for the real-time voice interaction includes: determining the interaction segment of the real-time voice interaction based on the operation information for the interaction-related document and a sound signal of the real-time voice interaction.

In some embodiments, wherein the sound signal of the real-time voice interaction includes a voice signal; and the determining the interaction segment of the real-time voice interaction based on the operation information for the interaction-related document and the sound signal of the real-time voice interaction includes: performing voice recognition on a voice signal period in the real-time voice interaction to obtain a voice recognition result; segmenting the real-time voice interaction based on a semantic division result of the voice recognition result to obtain candidate segments; and adjusting a time of the candidate segments based on the operation information for the interaction-related document to obtain the interaction segment.

In some embodiments, the segmenting the real-time voice interaction based on the semantic division result of the voice recognition result to the obtain candidate segments includes: performing semantic division on the voice recognition result to divide the voice recognition result into at least two segments; and determining a boundary point of a segment of the real-time voice interaction based on a time boundary point between two adjacent voice recognition results, to obtain two adjacent candidate segments of the real-time voice interaction.

In some embodiments, the adjusting the time of the candidate segments based on the operation information for the interaction-related document to obtain the interaction segment includes: determining a title switching time of the interaction-related document based on presentation position information of the interaction-related document; and adjusting start and end times of the candidate segments based on the title switching time, where the title switching time is used to indicate a time of switching different subparts of the interaction-related document.

In some embodiments, the presentation position information is determined based on at least one of the following: a title switching operation, document topic information corresponding to a document focus, or document topic information corresponding to a currently displayed comment.

In some embodiments, the adjusting the time of the candidate segments based on the operation information for the interaction-related document to obtain the interaction segment includes: in response to a time interval between start time points of two candidate segments being less than a preset first duration threshold, combining the two candidate segments.

In some embodiments, the determining the interaction segment of the real-time voice interaction based on the operation information for the interaction-related document and the sound signal of the real-time voice interaction includes: if a duration of a period in the sound signal that does not include a voice signal is greater than a preset first duration threshold, determining this period as a first-type interaction segment.

In some embodiments, the displaying the segment information of the determined interaction segment includes: constructing a hierarchical relationship of the interaction segment based on a voice signal and/or a document switching operation in the real-time voice interaction; and displaying the segment information having the hierarchical relationship.

In some embodiments, the constructing the hierarchical relationship of the interaction segment based on the voice signal and/or the document switching operation in the real-time voice interaction includes: determining, in response to no document switching operation being detected in the real-time voice interaction, a first-level interaction title of the real-time voice interaction based on a first-level document title of the interaction-related document.

In some embodiments, the constructing the hierarchical relationship of the interaction segment based on the voice signal and/or the document switching operation in the real-time voice interaction includes: determining, in response to a document switching operation being detected in the real-time voice interaction, a first-level interaction title of the real-time voice interaction based on a document identifier of the interaction-related document; and determining an N-level interaction title of the real-time voice interaction based on a document title of the interaction-related document, where N≥2.

In some embodiments, the displaying the segment information having the hierarchical relationship includes: displaying segment information of a second-type interaction segment as a first-level interaction title, where the interaction-related document is not displayed in the real-time voice interaction during the second-type interaction segment, and a duration of the second-type interaction segment is greater than a preset second duration threshold.

In some embodiments, the constructing the hierarchical relationship of the interaction segment based on the voice signal and/or the document switching operation in the real-time voice interaction includes: for a target interaction period in the real-time voice interaction, determining whether the target interaction period includes a third-type interaction segment based on the voice signal in the target interaction period, where the target interaction period corresponds to the same interaction-related document, and a determination condition of the third-type interaction segment includes a voice silent duration being greater than a third duration threshold; and if the target interaction period includes the third-type interaction segment, adjusting the level of the segment information downward for the interaction segment after the third-type interaction segment in the target interaction period, and displaying a preset indication identifier before the adjusted segment information.

In some embodiments, the segment information includes a segment topic; and the displaying the segment information having the hierarchical relationship includes: determining the segment topic of the interaction segment based on document content of the interaction-related document in the real-time voice interaction; and displaying the segment topic.

In some embodiments, the displaying the segment topic includes: displaying, in an interaction summary, the segment topic having the hierarchical relationship.

In some embodiments, the apparatus is further configured to: in response to a trigger operation on the segment topic, skip the recorded interaction video to the triggered interaction segment, and play the triggered interaction segment.

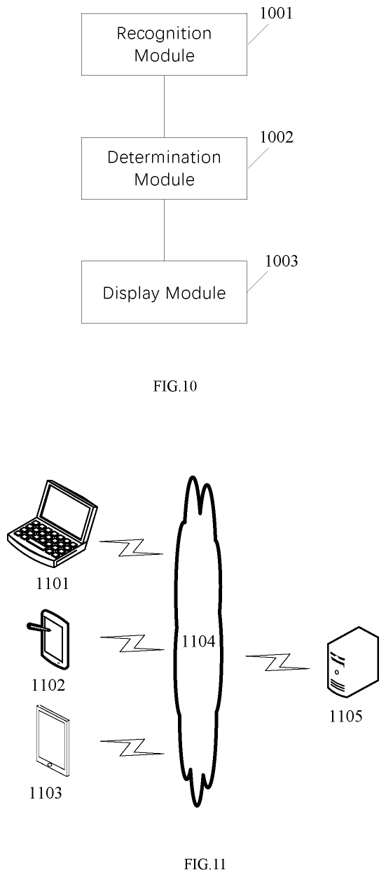

With further reference to FIG. 10, as an implementation of the method shown in the foregoing figures, the present disclosure provides an embodiment of an information display apparatus based on voice interaction. This apparatus embodiment corresponds to the method embodiment shown in FIG. 8, and this apparatus may be specifically applied to various electronic devices.

As shown in FIG. 10, the information display apparatus based on voice interaction in this embodiment includes: a recognition module 1001, a determination module 1002, and a display module 1003. The recognition module is configured to obtain a voice recognition result based on voice recognition performed on a voice signal period in a real-time voice interaction, the determination module is configured to determine an interaction segment of the real-time voice interaction based on the voice recognition result, and the display module is configured to display segment information of the determined interaction segment.

In some embodiments, the determining the interaction segment of the real-time voice interaction based on the voice recognition result includes: performing voice recognition on the voice signal period in the real-time voice interaction to obtain the voice recognition result; segmenting the real-time voice interaction based on a semantic division result of the voice recognition result to obtain candidate segments; and determining the interaction segment based on a time of the candidate segments.

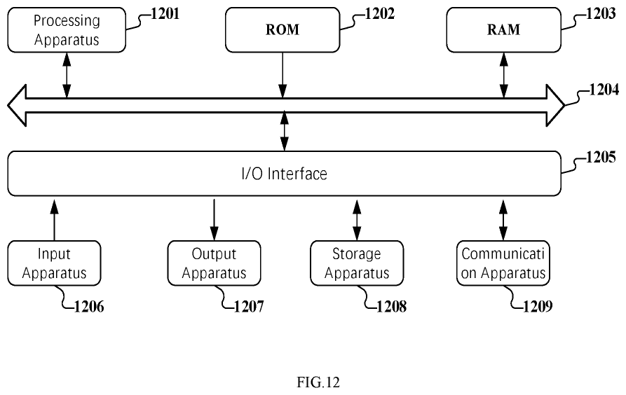

In some embodiments, the segmenting the real-time voice interaction based on the semantic division result of the voice recognition result to obtain the candidate segments includes: performing semantic division on the voice recognition result to divide the voice recognition result into at least two segments; and determining a boundary point of a segment of the real-time voice interaction based on a time boundary point between two adjacent voice recognition results, to obtain two adjacent candidate segments of the real-time voice interaction. Reference is made to FIG. 11, which shows an exemplary system architecture in which the information display method based on voice interaction according to an embodiment of the present disclosure may be applied.

As shown in FIG. 11, the system architecture may include terminal devices 1101, 1102, and 1103, a network 1104, and a server 1105. The network 1104 is configured to provide a medium for a communication link between the terminal devices 1101, 1102, and 1103 and the server 1105. The network 1104 may include various connection types, for example, wired, wireless communication links, or optical fiber cables.

The terminal devices 1101, 1102, and 1103 may interact with the server 1105 through the network 1104 to receive or send messages. Various client applications, for example, a web browser application, a search application, or a news information application, may be installed on the terminal devices 1101, 1102, and 1103. The client applications on the terminal devices 1101, 1102, and 1103 may receive an instruction of a user, and complete a corresponding function based on the instruction of the user, for example, adding corresponding information to the information based on the instruction of the user.

The terminal devices 1101, 1102, and 1103 may be hardware or software. When the terminal devices 1101, 1102, and 1103 are hardware, the terminal devices may be various electronic devices with a display screen and supporting web browsing, including but not limited to a smart phone, a tablet computer, an e-book reader, an MP3 (Moving Picture Experts Group Audio Layer III) player, an MP4 (Moving Picture Experts Group Audio Layer IV) player, a laptop portable computer, and a desktop computer. When the terminal devices 1101, 1102, and 1103 are software, the terminal devices may be installed in the foregoing listed electronic devices. The terminal devices may be implemented as multiple software or software modules (for example, software or software modules used to provide distributed services), or may be implemented as a single software or software module. This is not specifically limited here.

The server 1105 may be a server that provides various services, for example, receives an information acquisition request sent by the terminal devices 1101, 1102, and 1103, acquires display information corresponding to the information acquisition request through various manners based on the information acquisition request, and sends related data of the display information to the terminal devices 1101, 1102, and 1103.

It should be noted that the information display method based on voice interaction provided in the embodiment of the present disclosure may be performed by a terminal device. Accordingly, the information display apparatus based on voice interaction may be disposed in the terminal devices 1101, 1102, and 1103. In addition, the information display method based on voice interaction provided in the embodiment of the present disclosure may also be performed by the server 1105. Accordingly, the information display apparatus based on voice interaction may be disposed in the server 1105.

It should be understood that the numbers of terminal devices, networks, and servers in FIG. 11 are merely illustrative. Depending on implementation requirements, there may be any number of terminal devices, networks, and servers.

Reference is made to FIG. 12 below, which is a schematic diagram of a structure of an electronic device (for example, the terminal device or the server in FIG. 11) suitable for implementing an embodiment of the present disclosure. The terminal device in the embodiment of the present disclosure may include, but is not limited to, a mobile terminal such as a mobile phone, a notebook computer, a digital broadcast receiver, a PDA (personal digital assistant), a PAD (tablet computer), a PMP (portable multimedia player), and a vehicle-mounted terminal (such as a vehicle navigation terminal), and a fixed terminal such as a digital TV, a desktop computer. The electronic device shown in FIG. 12 is merely an example, and shall not impose any limitation on the function and scope of use of the embodiments of the present disclosure.

As shown in FIG. 12, the electronic device may include a processing apparatus (for example, a central processor, a graphics processor, etc.) 1201 that may perform a variety of appropriate actions and processing in accordance with a program stored in a read-only memory (ROM) 1202 or a program loaded from a storage apparatus 1208 into a random access memory (RAM) 1203. The RAM 1203 further stores various programs and data required for the operation of the electronic device. The processing apparatus 1201, the ROM 1202, and the RAM 1203 are connected to each other through a bus 1204. An input/output (I/O) interface 1205 is also connected to the bus 1204.

Generally, the following apparatuses may be connected to the I/O interface 1205: an input apparatus 1206 including, for example, a touch screen, a touchpad, a keyboard, a mouse, a camera, a microphone, an accelerometer, and a gyroscope; an output apparatus 1207 including, for example, a liquid crystal display (LCD), a speaker, and a vibrator; the storage apparatus 1208 including, for example, a magnetic tape and a hard disk; and a communication apparatus 1209. The communication apparatus 1209 may allow the electronic device to perform wireless or wired communication with other devices to exchange data. Although FIG. 12 shows the electronic device having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, the embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 1209, installed from the storage apparatus 1208, or installed from the ROM 1202. When the computer program is executed by the processing apparatus 1201, the above-mentioned functions defined in the method of the embodiment of the present disclosure are performed.

It should be noted that the foregoing computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a HTTP (hypertext transfer protocol), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The foregoing computer-readable medium carries one or more programs that, when executed by the electronic device, cause the electronic device to: determine an interaction segment of a real-time voice interaction based on operation information for an interaction-related document for the real-time voice interaction; and display segment information of the determined interaction segment.

In some embodiments, the determining the interaction segment of the real-time voice interaction based on the operation information for the interaction-related document for the real-time voice interaction includes: determining the interaction segment of the real-time voice interaction based on the operation information for the interaction-related document and a sound signal of the real-time voice interaction.

In some embodiments, wherein the sound signal of the real-time voice interaction includes a voice signal; and the determining the interaction segment of the real-time voice interaction based on the operation information for the interaction-related document and the sound signal of the real-time voice interaction includes: performing voice recognition on a voice signal period in the real-time voice interaction to obtain a voice recognition result; segmenting the real-time voice interaction based on a semantic division result of the voice recognition result to obtain candidate segments; and adjusting a time of the candidate segments based on the operation information for the interaction-related document to obtain the interaction segment.

In some embodiments, the adjusting the time of the candidate segments based on the operation information for the interaction-related document to obtain the interaction segment includes: determining a title switching time of the interaction-related document based on presentation position information of the interaction-related document; and adjusting start and end times of the candidate segments based on the title switching time.

In some embodiments, the presentation position information is determined based on at least one of the following: a title switching operation, document topic information corresponding to a document focus, or document topic information corresponding to a currently displayed comment.

In some embodiments, the adjusting the time of the candidate segments based on the operation information for the interaction-related document to obtain the interaction segment includes: in response to a time interval between start time points of two candidate segments being less than a preset first duration threshold, combining the two candidate segments.

In some embodiments, the determining the interaction segment of the real-time voice interaction based on the operation information for the interaction-related document and the sound signal of the real-time voice interaction includes: if a duration of a period in the sound signal that does not include a voice signal is greater than a preset first duration threshold, determining this period as a first-type interaction segment.

In some embodiments, the displaying the segment information of the determined interaction segment includes: constructing a hierarchical relationship of the interaction segment based on a voice signal and/or a document switching operation in the real-time voice interaction; and displaying the segment information having the hierarchical relationship.

In some embodiments, the constructing the hierarchical relationship of the interaction segment based on the voice signal and/or the document switching operation in the real-time voice interaction includes: determining, in response to no document switching operation being detected in the real-time voice interaction, a first-level interaction title of the real-time voice interaction based on a first-level document title of the interaction-related document.

In some embodiments, the constructing the hierarchical relationship of the interaction segment based on the voice signal and/or the document switching operation in the real-time voice interaction includes: determining, in response to a document switching operation being detected in the real-time voice interaction, a first-level interaction title of the real-time voice interaction based on a document identifier of the interaction-related document; and determining an N-level interaction title of the real-time voice interaction based on a document title of the interaction-related document, where N≥2.

In some embodiments, the displaying the segment information having the hierarchical relationship includes: displaying segment information of a second-type interaction segment as a first-level interaction title, where the interaction-related document is not displayed in the real-time voice interaction during the second-type interaction segment, and a duration of the second-type interaction segment is greater than a preset second duration threshold.

In some embodiments, the constructing the hierarchical relationship of the interaction segment based on the voice signal and/or the document switching operation in the real-time voice interaction includes:
for a target interaction period in the real-time voice interaction, determining whether the target interaction period includes a third-type interaction segment based on the voice signal in the target interaction period, where the target interaction period corresponds to the same interaction-related document, and a determination condition of the third-type interaction segment includes a voice silent duration being greater than a third duration threshold; and if the target interaction period includes the third-type interaction segment, adjusting the level of the segment information downward for the interaction segment after the third-type interaction segment in the target interaction period, and displaying a preset indication identifier before the adjusted segment information.

In some embodiments, the segment information includes a segment topic; and the displaying the segment information having the hierarchical relationship includes: determining the segment topic of the interaction segment based on document content of the interaction-related document in the real-time voice interaction; and displaying the segment topic.

In some embodiments, the displaying the segment topic includes: displaying, in an interaction summary, the segment topic having the hierarchical relationship.

In some embodiments, the electronic device is further configured to: in response to a trigger operation on the segment topic, skip the recorded interaction video to the triggered interaction segment, and play the triggered interaction segment.

The foregoing computer-readable medium carries one or more programs that, when executed by the electronic device, cause the electronic device to: obtain a voice recognition result based on voice recognition performed on a voice signal period in a real-time voice interaction; determine an interaction segment of the real-time voice interaction based on the voice recognition result; and display segment information of the determined interaction segment.

The computer program code for performing the operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented by software, or may be implemented by hardware. In some cases, the names of the units do not constitute a limitation on the units themselves. For example, the selection unit may also be described as a “unit for selecting the first-type pixels”.

The functions described hereinabove may be performed, at least in part, by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The foregoing descriptions are merely preferred embodiments of the present disclosure and explanations of the applied technical principles. Persons skilled in the art should understand that the scope of disclosure involved in the present disclosure is not limited to the technical solution formed by a specific combination of the foregoing technical features, and shall also cover other technical solutions formed by any combination of the foregoing technical features or their equivalent features without departing from the foregoing concept of disclosure. For example, the technical solution formed by replacing the foregoing features with the technical features with similar functions disclosed in the present disclosure (but not limited to).

In addition, although various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

What is claimed is

1. An information display method based on voice interaction, comprising:
determining an interaction segment of a real-time voice interaction based on operation information for an interaction-related document for the real-time voice interaction; and
displaying segment information of the determined interaction segment.

2. The method according to claim 1, wherein the determining the interaction segment of the real-time voice interaction based on the operation information for the interaction-related document for the real-time voice interaction comprises:
determining the interaction segment of the real-time voice interaction based on the operation information for the interaction-related document and a sound signal of the real-time voice interaction.

3. The method according to claim 2, wherein the sound signal of the real-time voice interaction comprises a voice signal; and
the determining the interaction segment of the real-time voice interaction based on the operation information for the interaction-related document and the sound signal of the real-time voice interaction comprises:
performing voice recognition on a voice signal period in the real-time voice interaction to obtain a voice recognition result;
segmenting the real-time voice interaction based on a semantic division result of the voice recognition result to obtain candidate segments; and
adjusting a time of the candidate segments based on the operation information for the interaction-related document to obtain the interaction segment.

4. The method according to claim 3, wherein the segmenting the real-time voice interaction based on the semantic division result of the voice recognition result to obtain the candidate segments comprises:
performing semantic division on the voice recognition result to divide the voice recognition result into at least two segments; and
determining a boundary point of a segment of the real-time voice interaction based on a time boundary point between two adjacent voice recognition results, to obtain two adjacent candidate segments of the real-time voice interaction.

5. The method according to claim 3, wherein the adjusting the time of the candidate segments based on the operation information for the interaction-related document to obtain the interaction segment comprises:
determining a title switching time of the interaction-related document based on presentation position information of the interaction-related document, wherein the title switching time is used to indicate a time of switching different subparts of the interaction-related document; and
adjusting start and end times of the candidate segments based on the title switching time, or the adjusting the time of the candidate segments based on the operation information for the interaction-related document to obtain the interaction segment comprises:
in response to a time interval between start time points of two candidate segments being less than a preset first duration threshold, combining the two candidate segments.

6. The method according to claim 5, wherein the presentation position information is determined based on at least one of the following: a title switching operation, document topic information corresponding to a document focus, or document topic information corresponding to a currently displayed comment.

7. (canceled)

8. The method according to claim 2, wherein the determining the interaction segment of the real-time voice interaction based on the operation information for the interaction-related document and the sound signal of the real-time voice interaction comprises:
if a duration of a period in the sound signal that does not include a voice signal is greater than a preset first duration threshold, determining this period as a first-type interaction segment.

9. The method according to claim 1, wherein the displaying the segment information of the determined interaction segment comprises:
constructing a hierarchical relationship of the interaction segment based on a voice signal and/or a document switching operation in the real-time voice interaction; and
displaying the segment information having the hierarchical relationship.

10. The method according to claim 9, wherein the constructing the hierarchical relationship of the interaction segment based on the voice signal and/or the document switching operation in the real-time voice interaction comprises:
Determining, in response to no document switching operation being detected in the real-time voice interaction, a first-level interaction title of the real-time voice interaction based on a first-level document title of the interaction-related document, where interaction titles at various levels correspond to interaction segments at various levels, or
the constructing the hierarchical relationship of the interaction segment based on the voice signal and/or the document switching operation in the real-time voice interaction comprises:
determining, in response to a document switching operation being detected in the real-time voice interaction, a first-level interaction title of the real-time voice interaction based on a document identifier of the interaction-related document; and
determining an N-level interaction title of the real-time voice interaction based on a document title of the interaction-related document, where N≥2, where interaction titles at various levels correspond to interaction segments at various levels, or
the constructing the hierarchical relationship of the interaction segment based on the voice signal and/or the document switching operation in the real-time voice interaction comprises:
for a target interaction period in the real-time voice interaction, determining whether the target interaction period includes a third-type interaction segment based on the voice signal in the target interaction period, where a segment topic of an interaction segment in the target interaction period belongs to the same interaction-related document, and a determination condition of the third-type interaction segment includes a voice silent duration being greater than a third duration threshold; and
if the target interaction period includes the third-type interaction segment, adding a preset indication identifier for the interaction segment after the third-type interaction segment in the target interaction period.

11. (canceled)

12. The method according to claim 9, wherein the displaying the segment information having the hierarchical relationship comprises:
displaying segment information of a second-type interaction segment as a first-level interaction title, where the interaction-related document is not displayed in the real-time voice interaction during the second-type interaction segment, and a duration of the second-type interaction segment is greater than a preset second duration threshold.

13. (canceled)

14. The method according to claim 1, wherein the segment information includes a segment topic; and
the displaying the segment information having the hierarchical relationship comprises:
determining the segment topic of the interaction segment based on document content of the interaction-related document in the real-time voice interaction; and
displaying the segment topic.

15. (canceled)

16. The method according to claim 14, wherein the method further comprises:
in response to a trigger operation on the segment topic, skipping a recorded interaction video to the triggered interaction segment, and playing the triggered interaction segment.

17. The method according to claim 1, wherein the displaying the segment information of the determined interaction segment comprises at least one of the following:
displaying the segment information of the determined interaction segment during the real-time voice interaction; or
displaying the segment information of the determined interaction segment in a voice recognition result corresponding to the real-time voice interaction during the real-time voice interaction and/or after the real-time voice interaction ends, or
the displaying the segment information of the determined interaction segment comprises at least one of the following:
displaying the segment information corresponding to a time point on a time axis corresponding to the real-time voice interaction;
displaying the segment information of the interaction segment in association with document content information; or
displaying the segment information of the interaction segment in association with a document structure, where the segment information includes a segment time.

18. (canceled)

19. (canceled)

20. An information display method based on voice interaction, comprising:
obtaining a voice recognition result based on voice recognition performed on a voice signal period in a real-time voice interaction;
determining an interaction segment of the real-time voice interaction based on the voice recognition result; and
displaying segment information of the determined interaction segment.

21. The method according to claim 20, wherein the determining the interaction segment of the real-time voice interaction based on the voice recognition result comprises:
performing voice recognition on the voice signal period in the real-time voice interaction to obtain the voice recognition result;
segmenting the real-time voice interaction based on a semantic division result of the voice recognition result to obtain candidate segments; and
determining the interaction segment based on a time of the candidate segments.

22. The method according to claim 21, wherein the segmenting the real-time voice interaction based on the semantic division result of the voice recognition result to obtain the candidate segments comprises:
performing semantic division on the voice recognition result to divide the voice recognition result into at least two segments; and
determining a boundary point of a segment of the real-time voice interaction based on a time boundary point between two adjacent voice recognition results, to obtain two adjacent candidate segments of the real-time voice interaction.

23. (canceled)

24. (canceled)

25. An electronic device, comprising:
one or more processors;
a storage apparatus configured to store one or more programs,
when the one or more programs are executed by the one or more processors, the one or more processors are caused to implement an information display method based on voice interaction comprising:
determining an interaction segment of a real-time voice interaction based on operation information for an interaction-related document for the real-time voice interaction; and
displaying segment information of the determined interaction segment.

26. A non-transitory computer-readable medium having a computer program stored thereon, wherein when the program is executed by a processor, the method according to claim 1 is implemented.

27. An electronic device, comprising:
one or more processors;
a storage apparatus configured to store one or more programs,
when the one or more programs are executed by the one or more processors, the one or more processors are caused to implement the method according to claim 20.

28. A non-transitory computer-readable medium having a computer program stored thereon, wherein when the program is executed by a processor, the method according to claim 20 is implemented.
